(19) United States
(12) Patent Application Publication
(10) Pub. No.: US 2025/0224586 A1
(43) Pub. Date: Jul. 10, 2025

(54) A MAGNETIC FILTER ASSEMBLY, MAGNETIC FILTER CAP ASSEMBLY, AND LENS ASSEMBLY THEREOF

(71) Applicant: JIANGMEN KASE OPTICS CO., LTD., Jiangmen city (CN)

(72) Inventor: Shiyong Huang, Jiangmen City (CN)

(21) Appl. No.: 18/036,377

(22) PCT Filed: Dec. 20, 2021
(86) PCT No.: PCT/CN2021/139484

§ 371 Date: May 10, 2023

(30) Foreign Application Priority Data
Apr. 22, 2021 (CN) 202120900916.8

(51) Int. Cl. G02B 7/00

(52) U.S. Cl. CPC G02B 7/006

(57) ABSTRACT

The present invention includes a magnetic filter assembly, a magnetic filter cap assembly, and a lens assembly thereof, wherein the magnetic filter assembly includes a filter; a main body, wherein the main body has a first mounting platform and a first attachment on the inside thereof, the first attachment part is a groove with an opening on the upper side, a second magnetic ring is installed in the groove of the first attachment, and clamped onto the inner wall of the first attachment, and the first attachment part is integrally formed with the first mounting platform; and an aluminum ring, wherein the aluminum ring is provided with a first mounting groove with an opening on the lower side of the groove, a first magnetic ring is fixedly installed in the first mounting groove, and the first magnetic ring and the second magnetic ring have opposite magnetic polarities.

### TECHNICAL FIELD

The present invention relates to but is not limited to the field of photographic equipment, and in particular, to a magnetic filter assembly, a magnetic filter cap assembly, and a lens assembly thereof.

### BACKGROUND

Filters are common photographic equipment that enables the adjustment of light and imaging effects. However, the filtering effect of a filter has already been fixed since its production, and it is usually necessary to prepare several different filters in order to achieve different filtering effects. Therefore, methods for achieving the rapid removal/installation of filters have become an important research and development direction for manufacturers.

Traditional filters are mainly attached to lenses with spring clips or threads, and the removal/installation process may be time-consuming if a plurality of filters have to be combined for use or different filters have to be replaced frequently. In order to solve this problem, some solutions in the prior art provide a magnet and a metal ring with the filter assembly, and have the filters installed in a stacked manner through the magnetic effect. In these solutions, the magnetic ring is usually disposed around the outside of the filter to form a binder, but it is difficult to ensure a perfect match between the contact faces of the filter and the magnetic ring, resulting in the possible displacement of the filter, and subsequently affecting the shooting effect.

In addition, in order to achieve the magnetic removal/installation of the filter, the metal ring needs to be pre-installed in the lens, so the photographer has to purchase a lens supplied with a metal ring. Since few options of such lens are available on the market and they are usually very expensive, the use of magnetic filters is costly.

### SUMMARY OF THE INVENTION

The following is a summary of the subject described herein. It is not intended to limit the scope of protection of the claims.

Embodiments of the present invention provide a magnetic filter assembly, a magnetic lens cap assembly, and a lens assembly thereof, which can improve the installation stability of filters and effectively reduce the costs of photographers for using the magnetic filters.

In a first aspect, an embodiment of the present invention provides a magnetic filter assembly, including:
a filter;
a main body, wherein the main body is provided with a first mounting platform and a first attachment part on the inner side thereof, the first attachment part is a groove with an opening on the upper side, a second magnetic ring is fixedly installed in the groove of the first attachment part and clamped onto the inner wall of the first attachment part, and the first attachment part is integrally formed with the first mounting platform; and
an aluminum ring, wherein the aluminum ring is provided with a first mounting groove with an opening on the lower side of the groove, a first magnetic ring is fixedly installed in the first mounting groove, the first magnetic ring and the second magnetic ring have opposite magnetic polarities, the position of the groove of the first attachment part matches the position of the first mounting groove, and the aluminum ring and the first attachment part are engaged with each other to clamp the filter.

The embodiment of the present invention includes: a filter; a main body, wherein the main body is provided with a first mounting platform and a first attachment part on the inside thereof, the first attachment part is a groove with an opening on the upper side, a second magnetic ring is fixedly installed in the groove of the first attachment part and clamped onto the inner wall of the first attachment part, and the first attachment part is integrally formed with the first mounting platform; and an aluminum ring, wherein the aluminum ring is provided with a first mounting groove with an opening on the lower side of the groove, a first magnetic ring is fixedly installed in the first mounting groove, the first magnetic ring and the second magnetic ring have opposite magnetic polarities, the position of the groove of the first attachment part matches the position of the first mounting groove, and the aluminum ring and the first attachment part are engaged with each other to clamp the filter. According to the solution provided by the embodiment of the present invention, it is possible to clamp the filter in the longitudinal direction by using the aluminum ring and the first attachment part, thereby improving the stability of the filter.

As a further improvement of the above-described solution, a plurality of first tooth parts are disposed on the inner side of the main body, a plurality of second tooth parts are disposed on the outer side of the aluminum ring, and the aluminum ring is fixed on the inner side of the main body by engagement of the second tooth parts with the first tooth parts.

As a further improvement of the above-described solution, the first magnetic ring and the second magnetic ring are attached against each side of the filter respectively.

As a further improvement of the above-described solution, a first anti-slip part is disposed on the outer side of the main body.

As a further improvement of the above-described solution, the filter includes at least one of the following: a UV protection filter; a neutral density (ND) filter; a circular polarizing (CPL) filter; a graduated neutral density filter; a starburst filter; and a soft focus filter.

In a second aspect, an embodiment of the present invention provides a magnetic filter assembly, including:
a filter cap assembly;
at least two magnetic filters, wherein the two adjacent magnetic filters are magnetically attached, and the filter cap assembly is removably attached to the magnetic filters; and
a lens attachment part, wherein the magnetic filter assembly is removably attached to the lens attachment part;
wherein the magnetic filters include:
a filter;
a main body, wherein the main body is provided with a first mounting platform and a first attachment part on the inner side thereof, the first attachment part is a groove with an opening on the upper side, a second magnetic ring is fixedly installed in the groove of the first attachment part and clamped onto the inner wall of the first attachment part, and the first attachment part is integrally formed with the first mounting platform; and
an aluminum ring, wherein the aluminum ring is provided with a first mounting groove with an opening on the lower side of the groove, a first magnetic ring is fixedly installed in the first mounting groove, the first magnetic ring and the second magnetic ring have opposite magnetic polarities, the position of the groove of the first attachment part matches the position of the first mounting groove, and the aluminum ring and the first attachment part are engaged with each other to clamp the filter.

The embodiment of the present invention includes: a filter cap assembly; at least two magnetic filters, wherein the two adjacent magnetic filters are magnetically attached, and the filter cap assembly is removably attached to the magnetic filters; and a lens attachment part, wherein the magnetic filter assembly is removably attached to the lens attachment part. According to the solution provided by the embodiment of the present invention, it is possible to realize the splicing of a plurality of magnetic filter assemblies and improve the applicability of the magnetic filter system.

As a further improvement of the above-described solution, the filter cap assembly includes a filter cap body, a film layer, and a second attachment part, the second attachment part is fixedly attached to the inner side of the filter cap body, a third magnetic ring is disposed in the second attachment part, the third magnetic ring and the first magnetic ring have opposite magnetic polarities, and the film layer is clamped between the third magnetic ring and the filter cap body.

As a further improvement of the above-described solution, a second mounting groove is disposed in the second attachment part, the third magnetic ring is disposed in the second mounting groove, and the position of the second mounting groove matches the position of the first mounting groove.

As a further improvement of the above-described solution, the lens attachment part includes an attachment ring and a third attachment part, the third attachment part is integrally formed on the lower side of the attachment ring, and male threads are disposed on the outer side of the third attachment part.

As a further improvement of the above-described solution, a fourth magnetic ring is disposed in the attachment ring, and the fourth magnetic ring and the second magnetic ring have opposite magnetic polarities.

In a third aspect, an embodiment of the present invention provides a magnetic filter assembly, including:
a filter cap, wherein the filter cap includes a first attachment ring, and a magnetic ring is disposed in the first attachment ring;
a metal ring, wherein the metal ring is tightly affixed to the first attachment ring under the magnetic effect of the magnetic ring; and
a lens part, wherein the lens part includes a filter and a frame, the filter is fixedly attached to the frame, and the metal ring is removably attached to the frame.

According to the embodiment in the third aspect of the present invention, the magnetic filter assembly has at least the following beneficial effects: the magnetic filter assembly includes: a filter cap, wherein the filter cap includes a first attachment ring, and a magnetic ring is disposed in the first attachment ring; a metal ring, wherein the metal ring is tightly affixed to the first attachment ring under the magnetic effect of the magnetic ring; and a lens part, wherein the lens part includes a filter and a frame, the filter is fixedly attached to the frame, and the metal ring is removably attached to the frame. According to the technical solution of the present invention, since the metal ring is magnetically attached to the first attachment ring of the filter cap, the metal ring can be installed in the frame of the lens part via the filter cap under the magnetic effect, and it is possible to directly achieve the combination of different filters with the magnetic filter assembly of the embodiment, and also achieve the detachability of the metal ring from the lens, which not only simplifies removal/installation but also effectively reduces the costs of photographers for using the magnetic filters.

As a further improvement of the above-described solution, the first attachment ring is provided with: a first groove, wherein the magnetic ring is disposed in the first groove; and a covering part, wherein the covering part covers the upper side of the first groove.

As a further improvement of the above-described solution, the filter cap further includes a second attachment ring, an anti-slip part is disposed on the outer side of the second attachment ring, and the first attachment ring is fixedly attached to the inner side of the second attachment ring.

As a further improvement of the above-described solution, a second groove is disposed on the outer side of the metal ring.

As a further improvement of the above-described solution, male threads are disposed on the outer side of the metal ring, and female threads matching the male threads are disposed on the inner side of the frame.

In a fourth aspect, an embodiment of the present invention provides a magnetic filter cap assembly, including: a filter cap, wherein the filter cap includes a first attachment ring, and a magnetic ring is disposed in the first attachment ring; and a metal ring, wherein the metal ring is tightly affixed to the first attachment ring under the magnetic effect of the magnetic ring.

According to the embodiment in the fourth aspect of the present invention, the magnetic filter cap assembly has at least the following beneficial effects: the magnetic filter cap assembly includes: a filter cap, wherein the filter cap includes a first attachment ring, and a magnetic ring is disposed in the first attachment ring; and a metal ring, wherein the metal ring is tightly affixed to the first attachment ring under the magnetic effect of the magnetic ring. According to the technical solution of the present invention, since the metal ring is magnetically attached to the first attachment ring of the filter cap, the metal ring can be installed on the lens via the filter cap under the magnetic effect, and it is possible to achieve the detachability of the metal ring from the lens, which not only simplifies removal/installation but also effectively reduces the costs of photographers for using the magnetic filters.

As a further improvement of the above-described solution, the first attachment ring is provided with: a first groove, wherein the magnetic ring is disposed in the first groove; and a covering part, wherein the covering part covers the upper side of the first groove.

As a further improvement of the above-described solution, the filter cap further includes a second attachment ring, an anti-slip part is disposed on the outer side of the second attachment ring, and the first attachment ring is fixedly attached to the inner side of the second attachment ring.

As a further improvement of the above-described solution, a second groove is disposed on the outer side of the metal ring.

In a fifth aspect, an embodiment of the present invention further provides a lens assembly, including the magnetic filter assembly as described in the third aspect, or the magnetic filter cap assembly as described in the fourth aspect.

According to the embodiment in the fifth aspect of the present invention, the lens assembly has at least the following beneficial effects: it includes the lens assembly with the magnetic filter assembly as described in the third aspect and the lens assembly with the magnetic filter cap assembly as described in the fourth aspect, and it is possible to achieve the detachability of the metal ring from the lens, which not only simplifies removal/installation but also effectively reduces the costs of photographers for using the magnetic filters.

Other features and advantages of the present invention will be disclosed below herein and partially become apparent from the specification or are understood through implementing the present invention. The objectives and other advantages of the present invention may be achieved and obtained by means of the construction specifically indicated in the specification, claims, and accompanying drawings.

### BRIEF DESCRIPTION OF THE DRAWINGS

The accompanying drawings are used to help further understand the technical solutions of the present invention and constitute a part of the specification for the purpose of explaining the technical solutions of the present invention together with the embodiments of the present invention, which do not constitute a limitation to the technical solutions of the present invention.

FIG. 1 is an exploded view of a magnetic filter system provided in an embodiment of the present invention;

FIG. 2 is a sectional view of a magnetic filter system provided in another embodiment of the present invention;

FIG. 3 is an exploded view of a magnetic filter assembly system provided in another embodiment of the present invention;

FIG. 4 is an exploded bottom view of a filter cap assembly provided in another embodiment of the present invention;

FIG. 5 is a three-dimensional top view of a second attachment part of a filter cap assembly provided in another embodiment of the present invention;

FIG. 6 is a three-dimensional view of a magnetic filter assembly provided in an embodiment of the present invention;

FIG. 7 is a front view of a filter cap provided in another embodiment of the present invention;

FIG. 8 is an exploded view of a filter cap provided in another embodiment of the present invention;

FIG. 9 is an enlarged perspective view of Part A in FIG. 6;

FIG. 10 is a front view of a metal ring provided in another embodiment of the present invention;

FIG. 11 is a three-dimensional view of a magnetic filter cap assembly provided in an embodiment of the present invention;

FIG. 12 is a front view of a magnetic filter assembly provided in another embodiment of the present invention when it is applied to a lens; and

FIG. 13 is a front view of a magnetic filter cap assembly provided in another embodiment of the present invention when it is applied to a lens.

### DETAILED DESCRIPTION OF THE EMBODIMENTS

In order to explain the objectives, technical solutions, and advantages of the present invention more clearly, the present invention will be further described in detail below with reference to the accompanying drawings and embodiments. It should be understood that the embodiments described herein are merely used to explain the present invention, but are not intended to limit the present invention.

It should be noted that, although the division of functional modules is carried out in the schematic diagrams of the equipment and the logical sequence is illustrated in the flow chart, in some cases, the step illustrated or described may be performed with a different division of functional modules from that shown in the schematic diagrams of the equipment or in a different sequence from that shown in the flow chart. The terms “first”, “second”, and the like in the specification, claims, or above-mentioned accompanying drawings are used to distinguish similar objects, and are not necessarily used to describe a specific order or sequence.

Embodiments of the present invention are further described below with reference to the accompanying drawings.

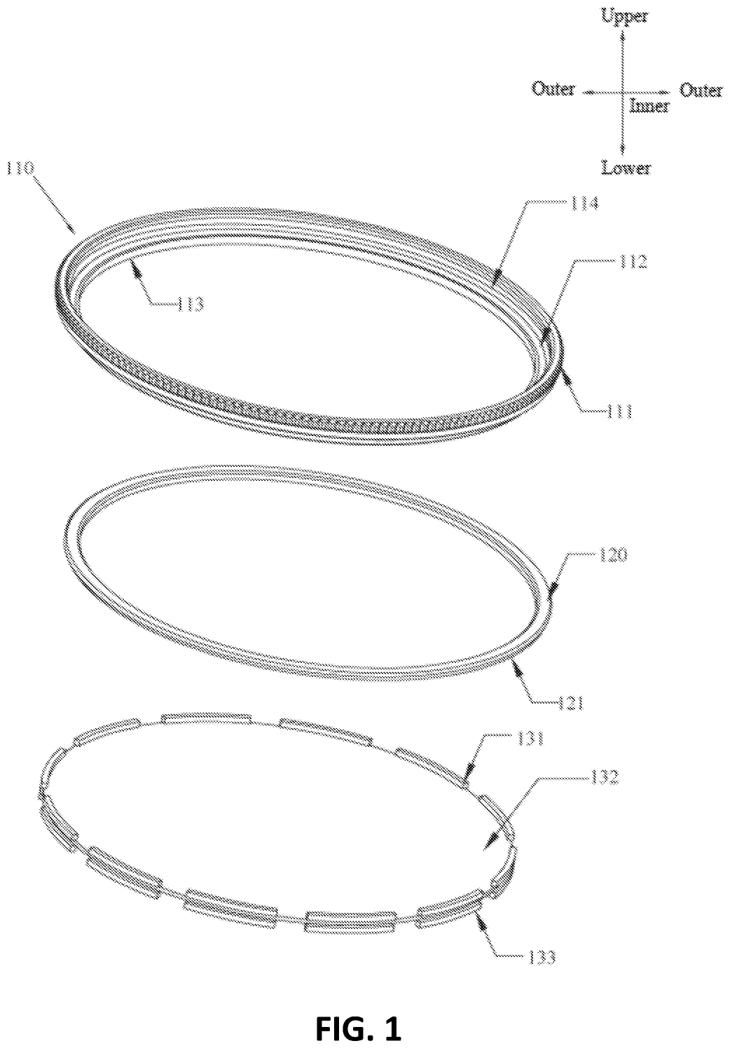

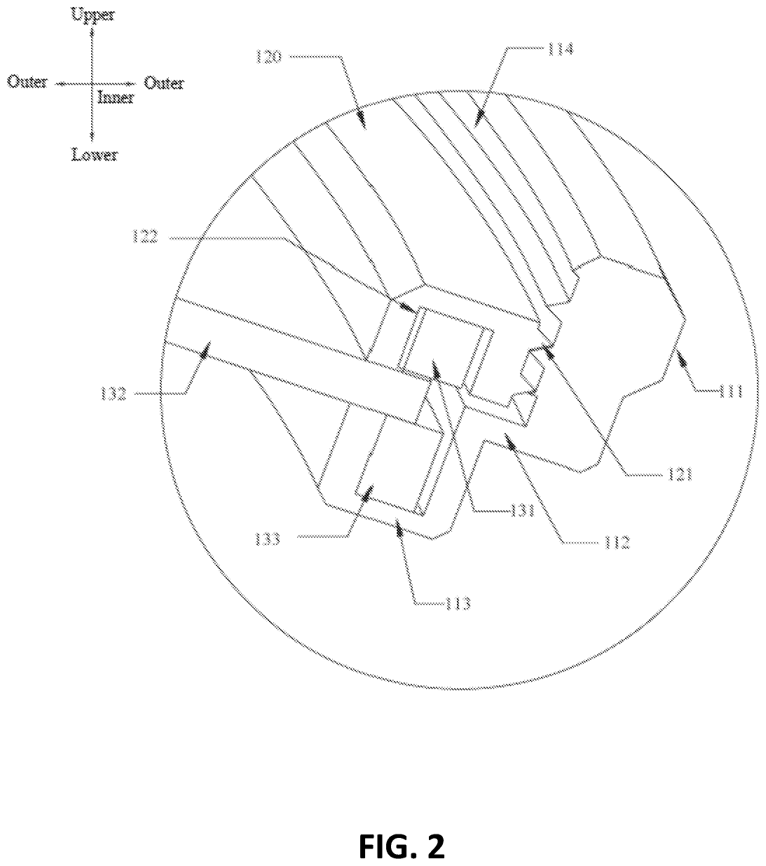

As shown in FIG. 1 and FIG. 2, an embodiment of the present invention provides a magnetic filter assembly 100, including:
a filter 132;
a main body 110, wherein the main body 110 is provided with a first mounting platform 112 and a first attachment part 113 on the inner side thereof, the first attachment part 113 is a groove with an opening on the upper side, a second magnetic ring 133 is fixedly installed in the groove of the first attachment part 113 and clamped onto the inner wall of the first attachment part 113, and the first attachment part 113 is integrally formed with the first mounting platform 112;
an aluminum ring 220, wherein the aluminum ring 220 is provided with a first mounting groove 122 with an opening on the lower side of the groove, a first magnetic ring 131 is fixedly installed in the first mounting groove 122, the first magnetic ring 131 and the second magnetic ring 133 have opposite magnetic polarities, the position of the groove of the first attachment part 113 matches the position of the first mounting groove 122, and the aluminum ring 220 and the first attachment part 113 are engaged with each other to clamp the filter 132.

It should be noted that the first mounting platform 112 may be a convex platform projecting inwardly, and its width may be adjusted according to the size of the aluminum ring 220 to just allow the attachment of the aluminum ring 220.

It may be understood that, in order to install the first magnetic ring 131, the first mounting groove 122 may be a groove with an opening on the lower side as shown in FIG. 2, or may be provided in the form of a mounting cavity optionally according to the actual need. It may be understood that, when the first mounting groove 122 features the structure shown in FIG. 2, its outer end is attached against the first mounting platform 112 while its inner end is attached against the filter 132, and the filter 132 can be fixed from the upper side.

It should be noted that the first attachment part 113 may be in the shape of a groove with an opening on the upper side as shown in FIG. 2, and its outer end is integrally formed with the first mounting platform 112 while its inner end is attached against the filter 132, and it can be engaged with the aluminum ring 220 to clamp the filter 132.

It is worth noting that the engagement of the aluminum ring 220 with the first attachment part 113 may be implemented in any way, for example, when a plurality of magnetic filter assemblies 100 are stacked under the magnetic effect, the second magnetic ring 133 of the magnetic filter assembly at the top and the first magnetic ring 131 of the magnetic filter assembly at the bottom form a downward pressure on the aluminum ring 220 under the magnetic effect due to their opposite magnetic polarities, thereby achieving attachment. In addition, it is also possible to attach one end of the aluminum ring 220 to the first mounting platform 112 by other attachment methods, such as by using glue, and the first attachment part 113 is made of hard materials such as plastics with a certain hardness which enables one end of the first attachment part 113 to support the filter 132, thus allowing it to be engaged with the aluminum ring 220 to achieve attachment. This embodiment does not limit the attachment method.

It is worth noting that the first magnetic ring 131 may be fixed in the first mounting groove 122 in any way, such as by using glue and other attachment media, or by size adjustment, to allow it to be clamped onto the inner wall of the first mounting groove 122, and the specific way is optional according to the actual need, which is not limited by this embodiment as long as it can achieve fixed installation. Similarly, the second magnetic ring 133 may also be fixed on the inner side of the first attachment part 113 by using attachment media or by the clamping method, which is not limited by this embodiment.

It is worth noting that some structures in the prior art use an iron fixing ring, which is easy to rust during use, and since the iron material is heavy, it may easily cause the filter to move down during use and make it unable to be used normally. Therefore, this embodiment preferably uses the aluminum ring 220 which can avoid rusting, and the aluminum material has a significant lightweight advantage over the iron material.

Referring to FIG. 2, in an embodiment, a plurality of first tooth parts 114 are disposed on the inner side of the main body 110, a plurality of second tooth parts 121 are disposed on the outer side of the aluminum ring 220, and the aluminum ring 220 is fixed on the inner side of the main body 110 by engagement of the second tooth parts 121 with the first tooth parts 114.

It should be noted that, by the engagement of the first tooth parts 114 with the second tooth parts 121, the fixation effect of the aluminum ring 220 can be enhanced in the longitudinal direction to improve the stability of the aluminum ring 220, further ensuring the clamping effect of the aluminum ring 220 on the filter 132.

It may be understood that the number of the first tooth parts 114 may be larger than that of the second tooth parts 121, and the first tooth parts are evenly distributed from top to bottom, therefore the attachment positions of the second tooth parts 121 may be adjusted to achieve the adjustment of the aluminum ring's position and the filter 132 with a wider range of thicknesses can be matched. The specific number of the first tooth parts 114 may be adjusted according to the actual need.

It may be understood that, by adjusting the shape of the first tooth parts 114, filters mounted in a standard threaded manner can also be mounted, so the magnetic filter assembly 100 of this embodiment can be used for filter mounting either under the magnetic effect or in a threaded manner, effectively increasing the scope of applicability.

Referring to FIG. 2, in an embodiment, the first magnetic ring 131 and the second magnetic ring 133 are attached against each side of the filter 132 respectively.

It should be noted that the first magnetic ring 131 and the second magnetic ring 133 are mainly used for magnetic fixation when a plurality of magnetic filter assemblies 100 are combined, and certainly, the first magnetic ring 131 may be attached against the upper side of the filter 132 while the second magnetic ring 133 may be attached against the lower side of the filter 132, which may further increase the number of the clamping force points on the filter 132 and improve the stability of the filter provided that the filter 132 is clamped by the aluminum ring 220 and the first attachment part 113.

Referring to FIG. 1, in an embodiment, a first anti-slip part 111 is disposed on the outer side of the main body 110.

It may be understood that, in the process of light filtering using the filter 132, it is usually necessary to adjust the filter's angle to achieve different filtering effects, so the first anti-slip part 111 is disposed on the outer side of the main body 110 to enhance the friction generated when the magnetic filter assembly 100 is rotated and improve the convenience of use. It may be understood that the shape of the first anti-slip part 111 may be adjusted according to the actual need, such as common stripes or regular patterns, which is not limited by this embodiment.

In an embodiment, the filter 132 includes at least one of the following:
a UV protection filter;
a neutral density (ND) filter;
a circular polarizing (CPL) filter;
a graduated neutral density filter;
a starburst filter; and
a soft focus filter.

It should be noted that the filter 132 may be a common type, such as a UV protection filter, a neutral density (ND) filter, a circular polarizing (CPL) filter, a graduated neutral density filter, a starburst filter, or a soft focus filter, as long as it can be installed by the method provided in this embodiment.

Referring to FIG. 1 to FIG. 3, in a second aspect, an embodiment of the present invention further provides a magnetic filter system, including:
a filter cap assembly 200;
at least two magnetic filter assemblies 100, wherein the two adjacent magnetic filter assemblies 100 are magnetically attached, and the filter cap assembly 200 is removably attached to the magnetic filter assemblies 100; and
a lens attachment part 300, wherein the magnetic filter assemblies 100 are removably attached to the lens attachment part 300.

Here, the magnetic filter assemblies 100 include:
a filter 132;
a main body 110, wherein the main body 110 is provided with a first mounting platform 112 and a first attachment part 113 on the inner side thereof, the first attachment part 113 is a groove with an opening on the upper side, a second magnetic ring 133 is fixedly installed in the groove of the first attachment part 113 and clamped onto the inner wall of the first attachment part 113, and the first attachment part 113 is integrally formed with the first mounting platform 112;
an aluminum ring 220, wherein the aluminum ring 220 is provided with a first mounting groove 122 with an opening on the lower side of the groove, a first magnetic ring 131 is fixedly installed in the first mounting groove 122, the first magnetic ring 131 and the second magnetic ring 133 have opposite magnetic polarities, the position of the groove of the first attachment part 113 matches the position of the first mounting groove 122, and the aluminum ring 220 and the first attachment part 113 are engaged with each other to clamp the filter 132.

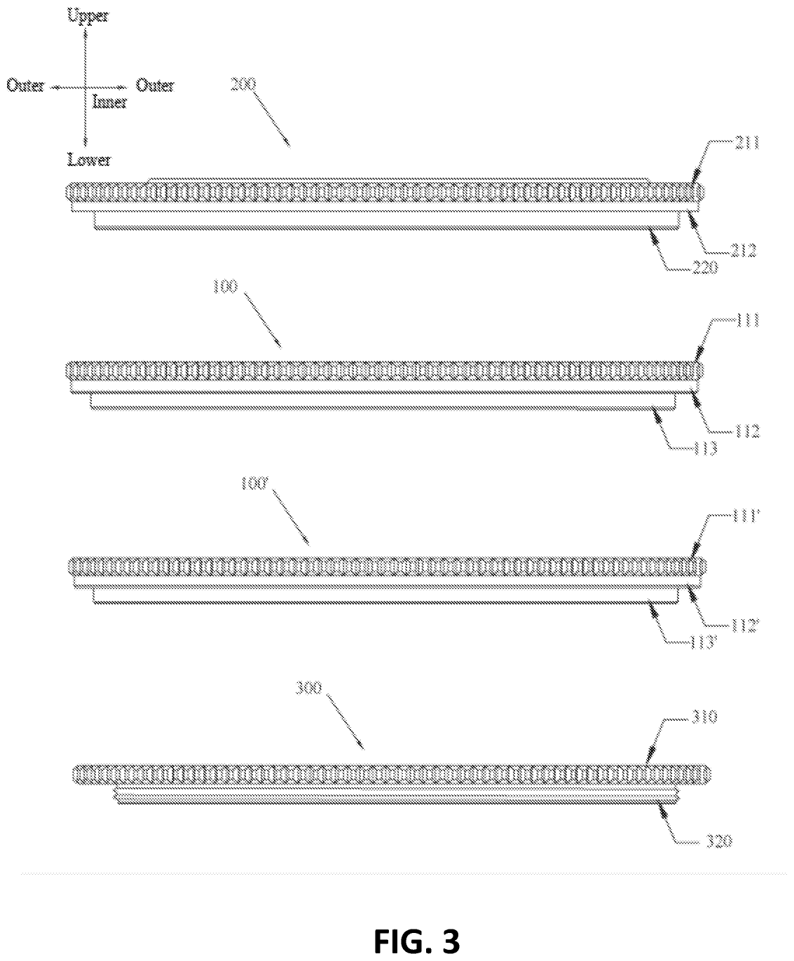

It should be noted that, for the convenience of expression, this embodiment uses the magnetic filter assemblies 100 to represent the magnetic filter assemblies respectively located on the upper side and on the lower side in FIG. 3, and the corresponding parts are treated the same, which will not be repeatedly elaborated herein.

It should be noted that the number of the magnetic filter assemblies 100 may be arbitrary and optional according to the actual need, which is not limited by this embodiment, and two assemblies are used as an example only for the convenience of expression.

It may be understood that, when one magnetic filter assembly 100 and the other magnetic filter assembly 100 are in contact, the first magnetic ring 131 in one magnetic filter assembly 100 is close to the second magnetic ring 133 in the other magnetic filter assembly 100, thus achieving attachment under the magnetic effect, and at the same time, the first attachment part 133 of one magnetic filter assembly 100 and the aluminum ring 220 of the other magnetic filter assembly 100 are in contact, thereby generating an additional downward pressure on the aluminum ring 220 of the other magnetic filter assembly 100, and further increasing the stability of the filter 132.

It may be understood that the lens attachment part 300 is used to attach the lens of the camera, and its size may be adjusted according to the size of the lens.

It is worth noting that the attachment of the lens attachment part 300 and the filter cap assembly 200 to the magnetic filter assemblies 100 may be implemented under the magnetic effect, i.e., a magnetic material capable of being attached to the first magnetic ring 131 and the second magnetic ring 133 under the magnetic effect is disposed on the lens attachment member 300 and the filter cap assembly 200 respectively for easy removal.

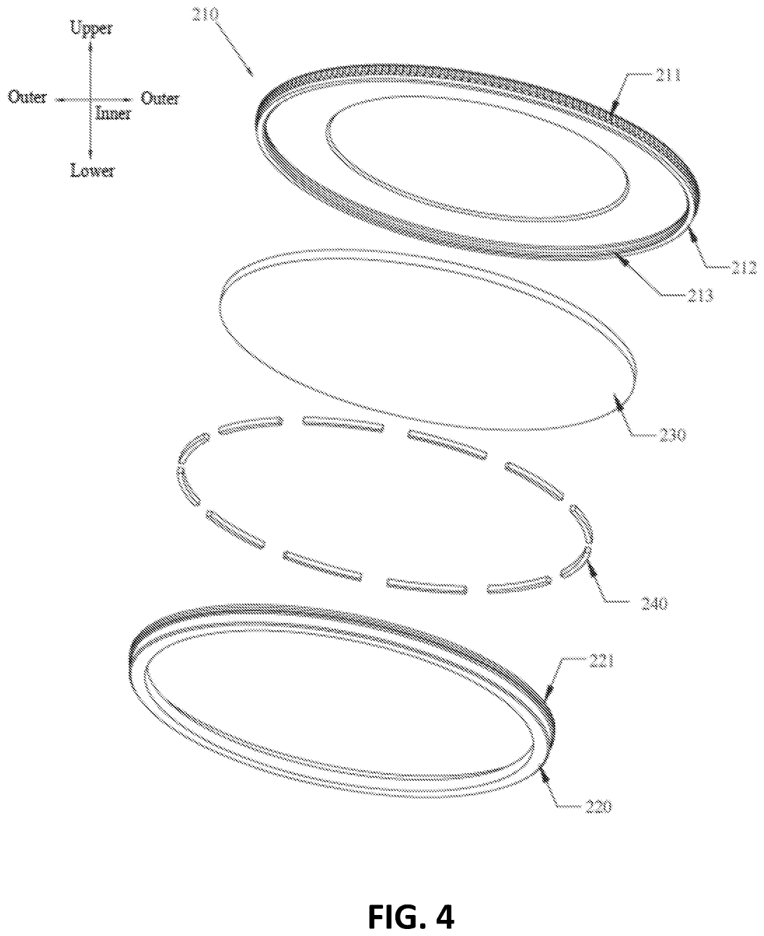

Referring to FIG. 4, in an embodiment, the filter cap assembly 200 includes a filter cap body 210, a film layer 230, and a second attachment part 220, wherein the second attachment part 220 is fixedly attached to the inner side of the filter cap body 210, a third magnetic ring 240 is disposed in the second attachment part 220, the third magnetic ring 240 and the first magnetic ring 131 have opposite magnetic polarities, and the film layer 230 is clamped between the third magnetic ring 240 and the filter cap body 210.

It should be noted that a flap 212 may also be disposed on the side of the filter cap body 210, and a second anti-slip part 211 may be disposed on the outer side of the flap 212, thereby improving the anti-slip effect of the operation. It may be understood that a first threaded part 213 may be disposed on the inner side of the flap 212, a second threaded part 221 may be disposed on the outer side of the second attachment part 220, and the attachment of the second attachment part 220 to the filter cap body 210 is achieved by the threaded fit between the second thread part 221 and the first thread part 213.

It may be understood that the third magnetic ring 240 is disposed in the second attachment part 220 to enable the removable attachment of the filter cap assembly 200 to the magnetic filter assembly under the magnetic effect, and certainly, the third magnetic ring 240 may also be replaced with a metal material as long as it can achieve the magnetic attachment to the first magnetic ring 131, which is not limited herein.

It should be noted that, in order to protect the filter 132, the film layer 230 may be disposed between the filter cap body 210 and the third magnetic ring 240, such as common EVA materials, to avoid damage to the filter 132 caused by the filter cap body 210.

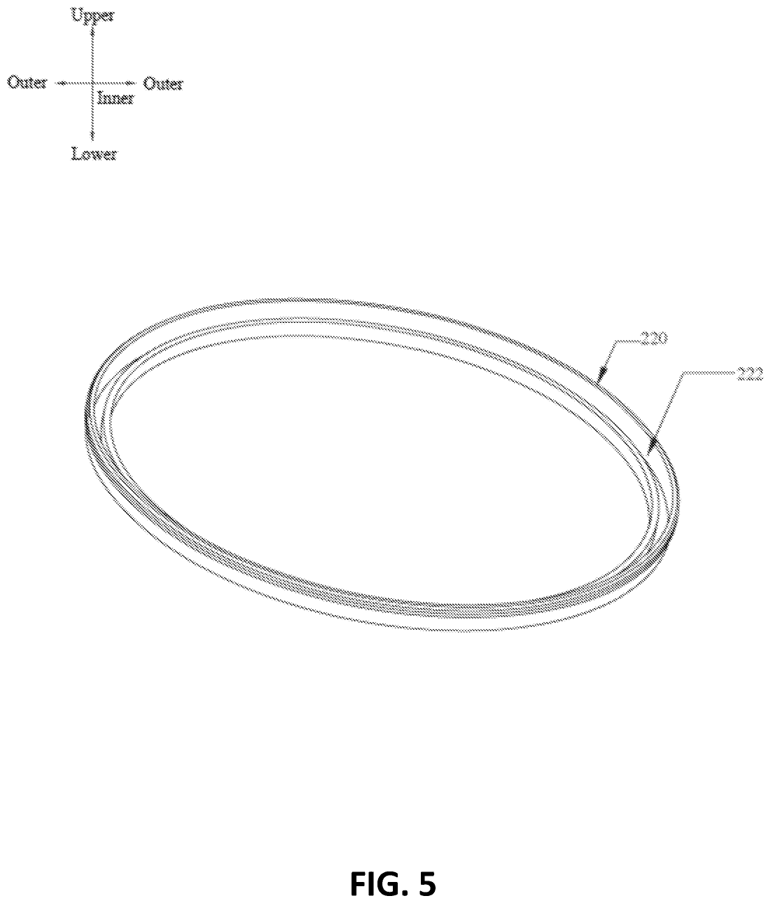

Referring to FIG. 5, in an embodiment, a second mounting groove 222 is disposed in the second attachment part 220, the third magnetic ring 240 is disposed in the second mounting groove 222, and the position of the second mounting groove 222 matches the position of the first mounting groove 122.

It should be noted that the second mounting groove 222 is disposed to achieve the placement of the third magnetic ring 240, which can reduce the longitudinal space of the filter cap assembly 200 and reduce the size of the magnetic filter system.

It should be noted that the position of the second mounting groove 222 matches the position of the first mounting groove 122, which enables the alignment of the third magnetic ring 240 with the first magnetic ring 131 to ensure a good magnetic effect.

In an embodiment, the lens attachment member 300 includes an attachment ring 310 and a third attachment part 320, wherein the third attachment part 320 is integrally formed on the lower side of the attachment ring 310, and male threads are disposed on the outer side of the third attachment part 320.

It may be understood by those skilled in the art that female threads are usually disposed on the light incoming side of the lens to attach the lens to various auxiliary devices, so the male threads are provided on the outer side of the third attachment part 320 to achieve the attachment to the lens. The specific size of the third attachment part 320 can be adjusted according to the actual need, which is not limited by this embodiment.

It may be understood that the third attachment part 320 is integrally formed with the attachment ring 310 to effectively improve the stability.

In an embodiment, a fourth magnetic ring is disposed in the attachment ring 310, wherein the fourth magnetic ring and the second magnetic ring 133 have opposite magnetic polarities.

It may be understood that the fourth magnetic ring (not shown in the figure) disposed in the attachment ring 310 can achieve the attachment to the second magnetic ring 133 in the magnetic filter assembly 100 under the magnetic effect, thereby facilitating removal/installation.

It should be noted that the fourth magnetic ring may also be installed by providing a mounting cavity in the attachment ring 310 as long as it can achieve the installation, which is not limited by this embodiment.

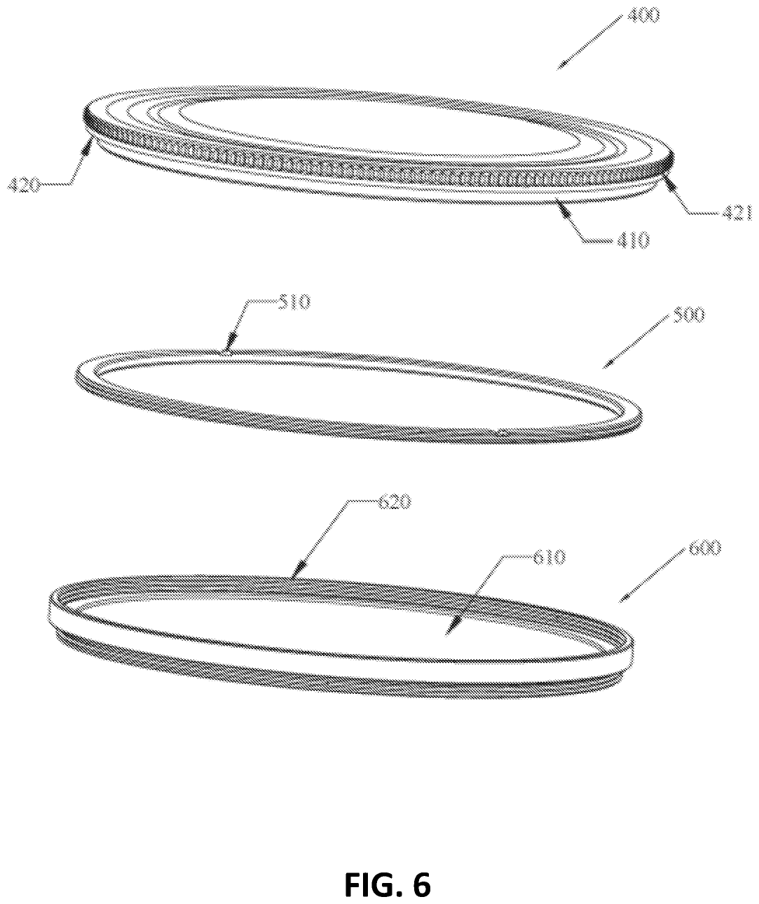

Referring to FIG. 6 to FIG. 8, an embodiment of the present invention provides a magnetic filter assembly, including:
a filter cap 400, wherein the filter cap 400 includes a first attachment ring 410, and a magnetic ring 412 is disposed in the first attachment ring 410;
a metal ring 500, wherein the metal ring 500 is tightly affixed to the first attachment ring 410 under the magnetic effect of the magnetic ring 412; and
a lens part 600, wherein the lens part 600 includes a filter 610 and a frame 620, the filter 610 is fixedly attached to the frame 620, and the metal ring 500 is removably attached to the frame 620.

It should be noted that the magnetic ring 412 is disposed in the first attachment ring 410, and in order to make full use of the magnetic force, the size of the first attachment ring 410 may be the same as that of the metal ring 500, thus enabling the metal ring 500 to be attached against each other under the magnetic effect of the magnetic ring 412. Since the metal ring 500 is attached to the first attachment ring 410 of the filter cap 400 under the magnetic effect, the metal ring 500 may be installed in the frame 620 of the lens part 600 via the filter cap 400 under the magnetic effect.

It should be noted that this embodiment does not limit the specific method for attaching the metal ring 500 to the frame 620, which may be as shown in FIG. 6. In this case, the frame 620 is provided with female threads, male threads matching the female threads of the frame 620 are disposed on the outer side of the metal ring 500, and the metal ring 500 is in threaded connection with the inner side of the frame 620. It may be understood that, after the metal ring 500 is installed, since the metal ring 500 is only attached to the filter cap 400 under the magnetic effect and the metal ring 500 is in threaded connection with the lens, it is convenient to detach the filter cap 400 from the metal ring 500, enabling the metal ring 500 to remain in the frame 620 and the magnetic filter 610 to be directly attached to the frame 620 under the magnetic effect. Compared with the solution of fixing the metal ring 500 in the lens, the solution of this embodiment does not require to purchase a special lens, and the metal ring 500 can be installed in the frame 620 of the lens part 600 via the filter cap 400 when the lens assembly is provided with the magnetic filter assembly according to the embodiments of the present invention, thereby enabling the stacking of different magnetic filters on the frame 620 and adjusting the shooting effect, which effectively improves the convenience of use of the metal ring 500 and reduces the cost for using the magnetic filter 610.

It should be noted that this embodiment does not limit the material of the metal ring 500, and it may be iron or stainless steel with magnetic effect, as long as it can achieve the attachment of the magnetic filter.

It should be noted that this embodiment does not limit the type of the filter 610, and the filter 610 includes but is not limited to the following types: a UV filter, a polarizing filter, a soft focus filter, a neutral density filter, a graduated neutral density filter, or a neutral density filter.

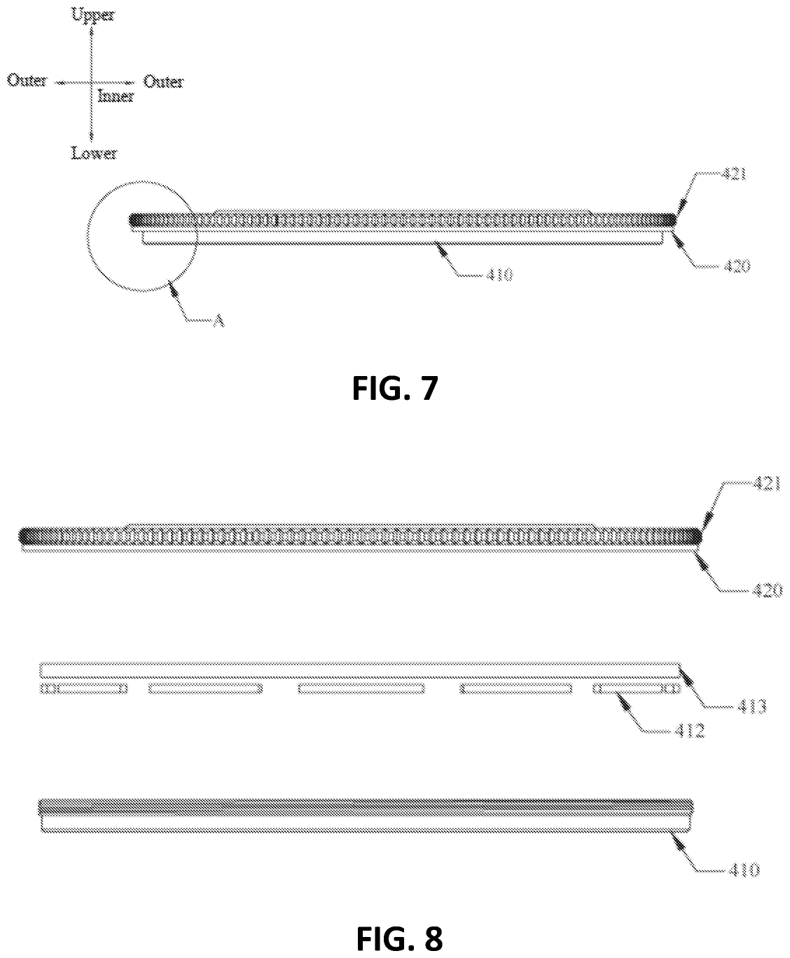

Referring to FIG. 7 to FIG. 9, in an embodiment, the first attachment ring 410 is provided with: a first groove 411, wherein the magnetic ring 412 is disposed in the first groove 411; and a covering part 413, wherein the covering part 413 covers the upper side of the first groove 411.

It should be noted that the first groove 411 is used to install the magnetic ring 412, and its size may be adjusted according to the size of the magnetic ring 412, for example, for the sake of a compact layout, the inner diameter of the first groove 411 may be slightly larger than that of the magnetic ring 412 to enable the magnetic ring 412 to be tightly clamped onto the inner wall of the first groove 411, thereby making the installation of the magnetic ring 412 more stable. Certainly, in order to reduce the influence of the groove wall on the magnetic effect of the magnetic ring 412, the lower wall of the first groove 411 may be relatively thin, and those skilled in the art are familiar with how to adjust the wall thickness of the first groove 411 according to the actual need, so it is not limited herein.

It should be noted that, since the magnetic ring 412 is circular, the first groove 411 may also be a concave groove, and certainly, if the magnetic ring 412 is made up of a plurality of curved magnetic strips as shown in FIG. 8, the first groove 411 may also be made up of a plurality of grooves integrally formed on the second attachment ring 420, as long as it can achieve the installation of the magnetic ring 412, which is not limited herein.

It should be noted that, referring to FIG. 8, the magnetic ring 412 in this embodiment consists of at least two curved magnetic strips, which can reduce the consumption of magnetic materials and effectively reduce the cost, and the at least two curved magnetic strips may feature the same size and curvature and evenly distributed in the first groove 411, thereby achieving a uniform force on the metal ring 500. The shape, size, curvature, and number of curved magnetic strips may be optional according to the actual need, which are not limited by this embodiment.

It should be noted that the lens cap 400 is further required to provide some protection to the lens when it is mounted on the lens assembly, therefore, the covering part 413 may be disposed on the inner side of the second attachment ring 420. The covering part 413 may be round as long as it can cover the lens, for example, the covering part 413 may be a plastic cover made of common EVA materials, which is not limited by this embodiment.

It should be noted that, in order to cover the lens, the covering part 413 needs to be attached against the inner side of the second attachment ring 420 to achieve a sealing effect. In this case, since the first groove 411 is located on the lower side of the second attachment ring 420, the covering part 413 also covers the upper side of the first groove 411, which can effectively prevent the magnetic ring 412 from falling off and achieve a sealing effect on the magnetic ring 412.

Referring to FIG. 7 to FIG. 9, in an embodiment, the filter cap 400 further includes a second attachment ring 420, wherein an anti-slip part 421 is disposed on the outer side of the second attachment ring 420, and the first attachment ring 410 is fixedly attached to the inner side of the second attachment ring 420.

It should be noted that the anti-slip part 421 may be an anti-slip pattern, as long as it can achieve an anti-slip effect and facilitate users to grasp.

It should be noted that since the first attachment ring 410 is attached against the metal ring 500, as shown in FIG. 11, when the metal ring 500 is installed in the frame 620, the first attachment ring 410 is actually located inside the frame 620, and a part of the attachment ring needs to be located on the outer side of the frame 620 in order to facilitate removal/installation. Therefore, the size of the second attachment ring 420 may be larger than that of the first attachment ring 410, and the diameter of the second attachment ring 420 may be slightly larger than that of the frame 620. In this way, the second attachment ring is clamped on the outer side of the frame 620 after installation, avoiding the filter cap 400 from being wholly trapped in the frame 620 to cause difficulty in removal.

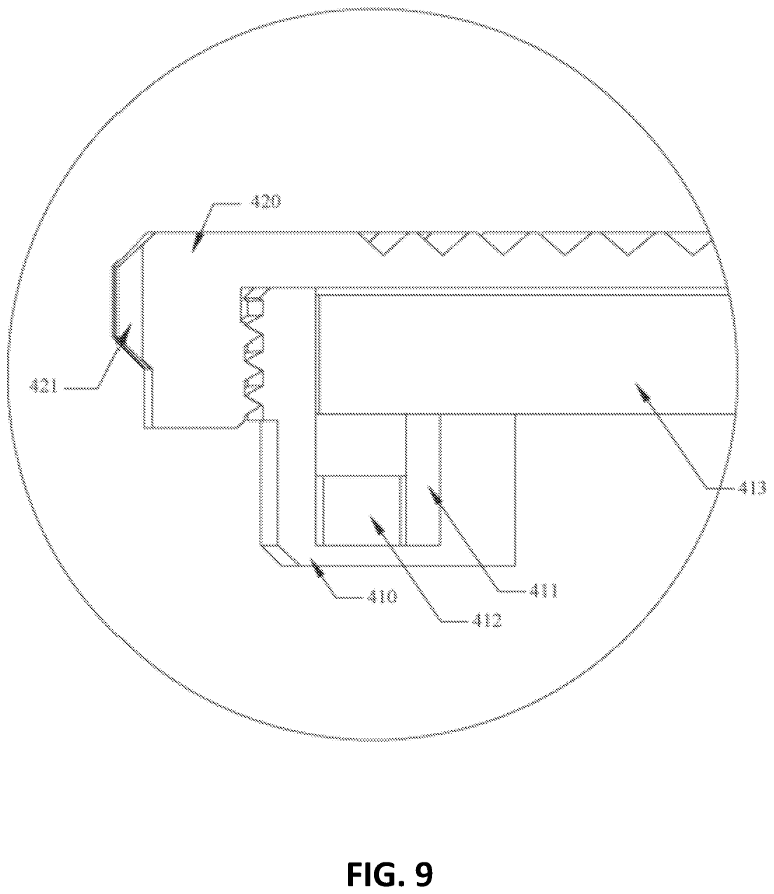

It should be noted that the first attachment ring 410 may be in threaded connection with the second attachment ring 420 as shown in FIG. 9, or they may be integrally formed, which is not limited by this embodiment.

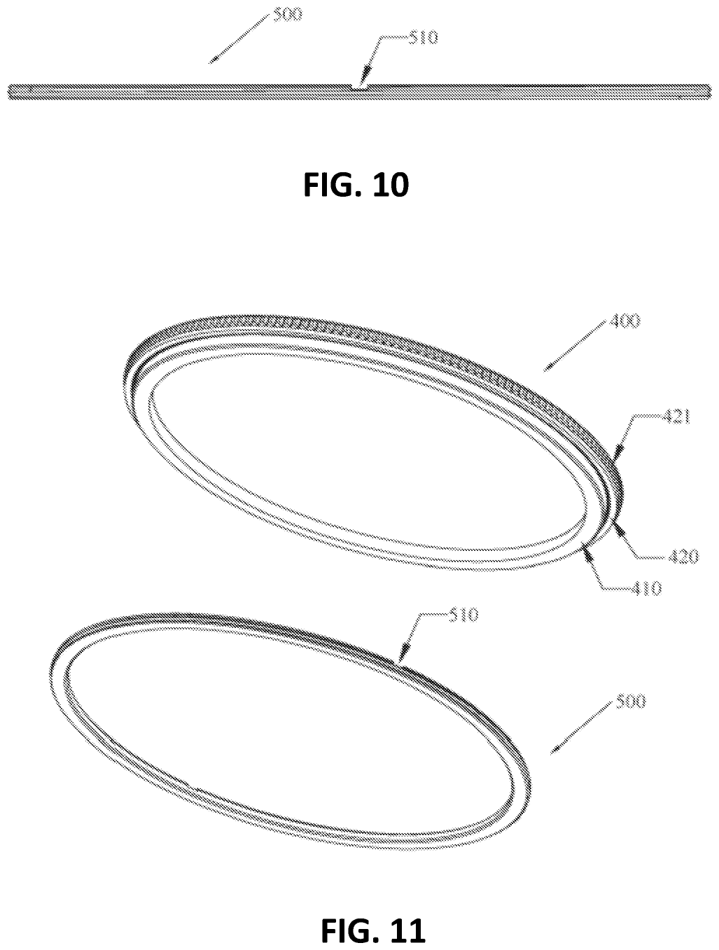

Referring to FIG. 6 and FIG. 10, in an embodiment, a second groove 510 is disposed on the outer side of the metal ring 500.

It should be noted that, as shown in FIG. 11, after the metal ring 500 is installed in the frame 620, since the metal ring 500 is attached to the filter cap 400 under the magnetic effect, it is necessary to remove the filter cap 400 before adding magnetic filters, for which this embodiment provides the second groove 510 on the outer side of the metal ring 500, which can provide a force support point for detaching the filter cap 400 from the metal ring 500, thereby simplifying the detachment of the filter cap 400 and improving the user experience.

It should be noted that the number and position of the second groove 510 may be arbitrary and adjusted according to the actual need, which are not limited by this embodiment.

In an embodiment, male threads are disposed on the outer side of the metal ring 500, and female threads matching the male threads are provided on the inner side of the frame 620.

It may be understood that, after the metal ring 500 is installed, since the metal ring 500 is attached to the filter cap 400 only under the magnetic effect and the metal ring 500 is in threaded connection with the lens, it is convenient to detach the filter cap 400 from the metal ring 500, enabling the metal ring 500 to remain in the frame 620 and the magnetic filter to be directly attached to the frame 620 under the magnetic effect.

In addition, referring to FIG. 11, an embodiment of the present invention further provides a magnetic filter cap assembly, including:

a filter cap 400, wherein the filter cap 400 includes a first attachment ring 410, and a magnetic ring 412 is disposed in the first attachment ring 410; and

a metal ring 500, wherein the metal ring 500 is tightly affixed to the first attachment ring 410 under the magnetic effect of the magnetic ring 412.

It should be noted that the characteristic principle of this embodiment may be described with reference to the magnetic filter assembly shown in FIG. 6 to FIG. 10, which is distinguished by that: in addition to being installed in the frame 620 of the lens part 600 as shown in FIG. 6, the metal ring 500 in this embodiment may also be directly installed in the lens assembly via the filter cap 400.

It should be noted that this embodiment does not limit the specific method for attaching the metal ring 500 to the lens, which may be as shown in FIG. 11. In this case, male threads are provided on the outer side of the metal ring 500, and female threads for mounting the filter cap 400 are usually disposed on the inner side of the lens. When the male threads are disposed on the outer side of the metal ring 500, by rotating the filter cap 400, the metal ring 500 may be driven under the magnetic effect to be in threaded connection with the lens. After the metal ring 500 is installed, since the metal ring 500 is attached to the filter cap 400 only under the magnetic effect and the metal ring 500 is in threaded connection with the lens, it is convenient to detach the filter cap 400 from the metal ring 500, enabling the metal ring 500 to remain in the lens and the magnetic filter to be directly attached to the lens under the magnetic effect. Compared with the solution of fixing the metal ring 500 in the lens, the solution of this embodiment does not require to purchase a special lens, and the removal/installation of the metal ring 500 can be achieved simply by making use of the female threads disposed on all lenses, effectively improving the convenience of use of the metal ring 500 and reducing the cost for using the magnetic filter 610; in addition, the metal ring 500 may also be clamped on the threaded end of the lens with a buckle structure under the action of the filter cap 400.

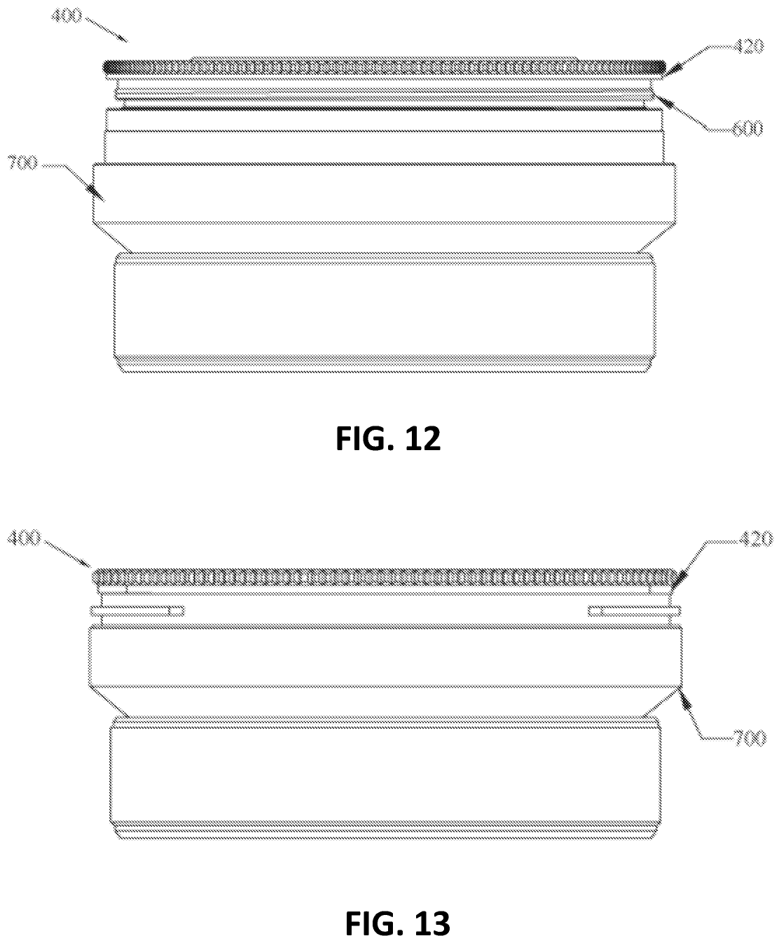

Additionally, referring to FIG. 12 and FIG. 13, another embodiment of the present invention further provides a lens assembly 700, including the magnetic filter assembly as described above, or the magnetic filter cap assembly as described above.

It should be noted that the magnetic filter cap assembly or the magnetic filter assembly may be installed on the light incoming side of the lens. According to the technical solution of the present invention, when the lens assembly 700 is provided with the magnetic filter assembly according to the embodiments of the present invention, the metal ring 500 can be installed in the frame 620 of the lens part 600 via the filter cap 400, thereby enabling the stacking of different magnetic filters on the frame 620 and adjusting the shooting effect, which effectively improves the convenience of use of the metal ring 500 and reduces the cost for using the magnetic filter 610; since female threads for mounting the filter cap 400 are usually disposed on the inner side of the lens, the metal ring 500 can be attached to the female threads of the lens assembly 700 via the filter cap 400 when the lens assembly 700 is provided with the magnetic filter cap assembly according to the embodiments of the present invention, thereby achieving the detachability of the metal ring 500 from the lens 700, which not only simplifies removal/installation but also effectively reduces the costs of photographers for using the magnetic filters.

The preferable embodiments of the present invention are described above in detail, but the present invention is not limited to the above embodiments, and those skilled in the art may develop various equivalent transformations or replacements without violating the spirit of the present invention. These equivalent transformations or replacements are included in the scope limited by the claims of the present invention.

What is claimed is:

1. A magnetic filter assembly, comprising:
a filter;
a main body, wherein the main body is provided with a first mounting platform and a first attachment part on the inner side thereof, the first attachment part is a groove with an opening on the upper side, a second magnetic ring is fixedly installed in the groove of the first attachment part and clamped onto the inner wall of the first attachment part, and the first attachment part is integrally formed with the first mounting platform; and
an aluminum ring, wherein the aluminum ring is provided with a first mounting groove with an opening on the lower side of the groove, a first magnetic ring is fixedly installed in the first mounting groove, the first magnetic ring and the second magnetic ring have opposite magnetic polarities, the position of the groove of the first attachment part matches the position of the first mounting groove, and the aluminum ring and the first attachment part are engaged with each other to clamp the filter.

2. A magnetic filter assembly according to claim 1, wherein a plurality of first tooth parts are disposed on the inner side of the main body, a plurality of second tooth parts are disposed on the outer side of the aluminum ring, and the aluminum ring is fixed on the inner side of the main body by engagement of the second tooth parts with the first tooth parts.

3. A magnetic filter assembly according to claim 1, wherein the first magnetic ring and the second magnetic ring are attached against each side of the filter respectively.

4. A magnetic filter assembly according to claim 1, wherein a first anti-slip part is disposed on the outer side of the main body.

5. A magnetic filter assembly according to claim 1, wherein the filter comprises at least one of the following:
a UV protection filter;
a neutral density (ND) filter;
a circular polarizing (CPL) filter; a graduated neutral density filter; a starburst filter; and
a soft focus filter.

6. A magnetic filter assembly, comprising:
a filter cap assembly;
at least two magnetic filter assemblies, wherein the two adjacent magnetic filter assemblies are magnetically attached, and the filter cap assembly is removably attached to the magnetic filter assemblies;
a lens attachment part, wherein the magnetic filter assembly is removably attached to the lens attachment part;
wherein the magnetic filters comprise:
a filter;
a main body, wherein the main body is provided with a first mounting platform and a first attachment part on the inner side thereof, the first attachment part is a groove with an opening on the upper side, a second magnetic ring is fixedly installed in the groove of the first attachment part and clamped onto the inner wall of the first attachment part, and the first attachment part is integrally formed with the first mounting platform; and
an aluminum ring, wherein the aluminum ring is provided with a first mounting groove with an opening on the lower side of the groove, a first magnetic ring is fixedly installed in the first mounting groove, the first magnetic ring and the second magnetic ring have opposite magnetic polarities, the position of the groove of the first attachment part matches the position of the first mounting groove, and the aluminum ring and the first attachment part are engaged with each other to clamp the filter.

7. A magnetic filter assembly according to claim 6, wherein the filter cap assembly comprises a filter cap body, a film layer, and a second attachment part, the second attachment part is fixedly attached to the inner side of the filter cap body, a third magnetic ring is disposed in the second attachment part, the third magnetic ring and the first magnetic ring have opposite magnetic polarities, and the film layer is clamped between the third magnetic ring and the filter cap body.

8. A magnetic filter assembly according to claim 7, wherein a second mounting groove is disposed in the second attachment part, the third magnetic ring is disposed in the second mounting groove, and the position of the second mounting groove matches the position of the first mounting groove.

9. A magnetic filter assembly according to claim 6, wherein the lens attachment part comprises an attachment ring and a third attachment part, the third attachment part is integrally formed on the lower side of the attachment ring, and male threads are disposed on the outer side of the third attachment part.

10. A magnetic filter assembly according to claim 9, wherein a fourth magnetic ring is disposed in the attachment ring, and the fourth magnetic ring and the second magnetic ring have opposite magnetic polarities.

11. A magnetic filter assembly, comprising:
a filter cap, wherein the filter cap comprises a first attachment ring, and a magnetic ring is disposed in the first attachment ring;
a metal ring, wherein the metal ring is tightly affixed to the first attachment ring under the magnetic effect of the magnetic ring; and
a lens part, wherein the lens part comprises a filter and a frame, the filter is fixedly attached to the frame, and the metal ring is removably attached to the frame.

12. A magnetic filter assembly according to claim 11, wherein the first attachment ring is provided with a first groove, wherein the magnetic ring is disposed in the first groove; and a covering part, wherein the covering part covers the upper side of the first groove.

13. A magnetic filter assembly according to claim 11, wherein the filter cap further comprises a second attachment ring, an anti-slip part is disposed on the outer side of the second attachment ring, and the first attachment ring is fixedly attached to the inner side of the second attachment ring.

14. A magnetic filter assembly according to claim 11, wherein a second groove is disposed on the outer side of the metal ring.

15. A magnetic filter assembly according to claim 11, wherein male threads are disposed on the outer side of the metal ring, and female threads matching the male threads are disposed on the inner side of the frame.

16. A magnetic filter cap assembly, comprising:
a filter cap, wherein the filter cap comprises a first attachment ring, and a magnetic ring is disposed in the first attachment ring; and
a metal ring, wherein the metal ring is tightly affixed to the first attachment ring under the magnetic effect of the magnetic ring.

17. A magnetic filter cap assembly according to claim 16, wherein the first attachment ring is provided with:
a first groove, wherein the magnetic ring is disposed in the first groove; and
a covering part, wherein the covering part covers the upper side of the first groove.

18. A magnetic filter cap assembly according to claim 16, wherein the filter cap further comprises a second attachment ring, an anti-slip part is disposed on the outer side of the second attachment ring, and the first attachment ring is fixedly attached to the inner side of the second attachment ring.

19. A magnetic filter cap assembly according to claim 16, wherein: a second groove is disposed on the outer side of the metal ring.

20. A lens assembly, comprising:
a magnetic filter assembly, wherein the magnetic filter assembly comprises:
a filter cap, wherein the filter cap comprises a first attachment ring, and a magnetic ring is disposed in the first attachment ring;
a metal ring, wherein the metal ring is tightly affixed to the first attachment ring under the magnetic effect of the magnetic ring; and
a lens part, wherein the lens part comprises a filter and a frame, the filter is fixedly attached to the frame, and the metal ring is removably attached to the frame;
or,
comprises a magnetic filter cap assembly, wherein the magnetic filter cap assembly comprises: a filter cap, wherein the filter cap comprises a first attachment ring, and a magnetic ring is disposed in the first attachment ring; and
a metal ring, wherein the metal ring is tightly affixed to the first attachment ring under the magnetic effect of the magnetic ring.
